(19) United States
(12) Patent Application Publication
(10) Pub. No.: US 2019/0084200 A1
(43) Pub. Date: Mar. 21, 2019

(54) MOLDED RESIN COMPONENT, METHOD OF MANUFACTURING THE MOLDED RESIN COMPONENT, AND PRINTER HAVING THE MOLDED RESIN COMPONENT AS EXTERIOR SURFACE THEREOF

(71) Applicant: CANON KABUSHIKI KAISHA, Tokyo (JP)

(72) Inventor: Kei Oikawa, Kawasaki-shi (JP)

(21) Appl. No.: 16/128,877

(22) Filed: Sep. 12, 2018

(30) Foreign Application Priority Data
Sep. 21, 2017 (JP) 2017-180811

(51) Int. Cl. B29C 45/00; B29C 45/26

(52) U.S. Cl. CPC B29C 45/0025; B29L 2031/767; B29C 2045/0034; B29C 45/26

(57) ABSTRACT

A method of manufacturing a molded resin component having a decorative pattern by filling a cavity with resin includes using a mold set in which a concave portion is formed along a boundary portion between the plurality of pieces, the concave portion being used to form one portion of the convex portion of the decorative pattern, or using a mold set including a step formed when a base material is cut, and when a cutting tool is replaced at a position where a concave portion is to be formed, the concave portion being used to form one portion of the convex portion of the decorative pattern.

### BACKGROUND OF THE INVENTION

### Field of the Invention

The present invention relates to a molded resin component on which outer surface a decorative pattern portion is formed, a method of manufacturing the molded resin component, and a printer having the molded resin component as an exterior surface of the printer.

### Description of the Related Art

In recent years, exterior components of electronic devices are often made with a molded resin component on which a decorative pattern is formed, for design, weight reduction, cost, and mass production. The molded resin component is obtained by filling a mold with a thermoreversible resin such as ABS or high impact polystyrene (HIPS), then transferring the shape of the mold, which includes a decorative pattern, to the resin by applying pressure to the resin, then cooling the resin, and then taking out the resin from the mold.

In particular, for exterior components, unevenness of the decorative pattern may significantly affect the external aesthetic appearance of the exterior components. Thus, it is desired to increase the accuracy of forming the decorative pattern. In conventional molded resin components, however, a step may be formed at a conspicuous position, visually impairing the aesthetic appearance.

One factor by which the step is formed is unevenness of a molding surface of a mold, which forms the decorative pattern. In the production of the mold, the molding surface is formed by cutting a base material with a cutting tool. In this case, because of durability of the cutting tool, the cutting tool may be replaced with another during formation of a single molding surface. When the cutting tool is replaced with the other, the shape of the molding surface may be changed, because the shape of the other cutting tool differs from that of the cutting tool having been replaced. Typically, the height of a base surface, which is a reference surface and on which a convex decorative pattern is formed, may be changed by the replacement of the cutting tool, at a position in the base surface. This may cause a visually conspicuous step (tools-originated step).

Another factor is a difference in position between pieces of the mold, which is produced at a boundary between the pieces. For example, a difference in position between a slide piece and a cavity piece causes a parting step, and a difference in height between an insert piece and the cavity piece causes a step which is formed at a boundary of the insert piece.

These steps are transferred to the molded resin component. Thus, if the steps are formed at visually conspicuous positions, the steps will cause quality deterioration in external appearance.

One solution to make the steps visually less conspicuous is to coat the surface of the molded resin component with paint, to reduce the height of the steps. When the molded resin component is partly or wholly covered with a sufficient thickness of paint, and the paint dries, the steps can be less conspicuous.

Another solution to make the steps less conspicuous is described in Japanese Patent Application Publication No. 2007-331233, which does not pertain to the field of the molded resin component. In this solution, a decorative sheet having a concave and convex pattern on its exterior surface is stuck to a material used for making an exterior surface, to camouflage a step of a joining end of the material for improving quality of the external appearance.

However, the above-described solution to coat the surface of the molded resin component with the paint needs an additional coating process which increases cost. In addition, since the coating decreases visibility of the decorative pattern transferred to the surface of the molded resin component, the aesthetic appearance in design will be impaired.

In addition, if the solution described in Japanese Patent Application Publication No. 2007-331233 is used for the molded resin component, the additional process for sticking the decorative sheet having the concave and convex pattern will increase cost. Moreover, the shape of the molded resin component may make it difficult to stick the decorative sheet to the molded resin component without producing any wrinkles.

### SUMMARY OF THE INVENTION

According to a first aspect of the present invention, a method of manufacturing a molded resin component having a regular decorative pattern by filling a cavity with resin, the cavity being formed by a mold set including a first piece and a second piece, the regular decorative pattern having a convex portion, the method includes using a mold set in which a concave part is formed along a boundary portion between the first piece and the second piece, the concave part being used to form one portion of the convex portion of the regular decorative pattern, or using a mold set including a first base surface, a second base surface which positioned higher than the first base surface, a concave part between the first base surface and the second base surface, and a step formed by a cutting tool being replaced at a position where the concave part is to be formed, the concave part being used to form one portion of the convex portion of the regular decorative pattern.

According to a second aspect of the present invention, a molded resin component having a regular decorative pattern, the regular decorative pattern including a convex portion, the molded resin component includes a step in one portion of the convex portion of the regular decorative pattern.

According to a third aspect of the present invention, a printer having a molded resin component on an exterior surface thereof, the molded resin component including a regular decorative pattern, the regular decorative pattern including a convex portion, the printer includes a step in one portion of the convex portion of the regular decorative pattern.

Further features of the present invention will become apparent from the following description of exemplary embodiments with reference to the attached drawings.

### BRIEF DESCRIPTION OF THE DRAWINGS

FIG. 1 is a perspective view of a printer in which a molded resin component of an embodiment is used as an exterior component.

FIG. 2 schematically illustrates a decorative pattern of an embodiment.

FIG. 3A is a schematic sectional view of a document cover.

FIG. 3B is a schematic top view of the document cover.

FIG. 4 is an external view of a mold used to make the molded resin component of the embodiment.

FIG. 5 is a sectional view of a mold set of an embodiment.

FIG. 6 is an enlarged sectional view illustrating a parting step of an embodiment.

FIG. 7 is a sectional view of the vicinity of a boundary between a cavity piece and a slide piece of an embodiment.

FIG. 8 is a sectional view for illustrating the mechanism of occurrence of the parting step.

FIG. 9 is an enlarged sectional view illustrating a tools-originated step of an embodiment.

FIG. 10 is an enlarged sectional view illustrating a tools-originated step of an embodiment.

FIG. 11 is a perspective view illustrating a configuration of a machine tool used to make the mold.

FIG. 12 illustrates a tools-originated step of an embodiment.

FIG. 13 illustrates a conventional tools-originated step.

FIG. 14 is a top view of a mold set of an embodiment.

FIG. 15 is a partial sectional view of a mold set which was used for comparative examples of the parting step.

FIG. 16A is a plan view illustrating machining areas of a cavity piece of an embodiment.

FIG. 16B is a plan view illustrating patterns formed on the cavity piece of the embodiment.

FIG. 17A is a plan view illustrating machining areas of a cavity piece of an embodiment.

FIG. 17B is a plan view illustrating patterns formed on the cavity piece of the embodiment.

FIG. 18 is a sectional view illustrating a comparative example of the tools-originated step.

FIG. 19 is a sectional view illustrating a comparative example of the tools-originated step.

### DESCRIPTION OF THE EMBODIMENTS

Hereinafter, some embodiments of the present invention, that is, a molded resin component, a method of manufacturing the molded resin component, and a printer having the molded resin component as an exterior surface of the printer will be described with reference to the accompanying drawings. The present invention can be applied to resin components having decorative patterns. Examples of the resin components include exterior components of home electrical products and electronic products, and exterior and interior components of vehicles such as automobiles.

### First Embodiment

In a first embodiment, there will be described an example in which the present invention is applied to an exterior component of a printer having a document reader.

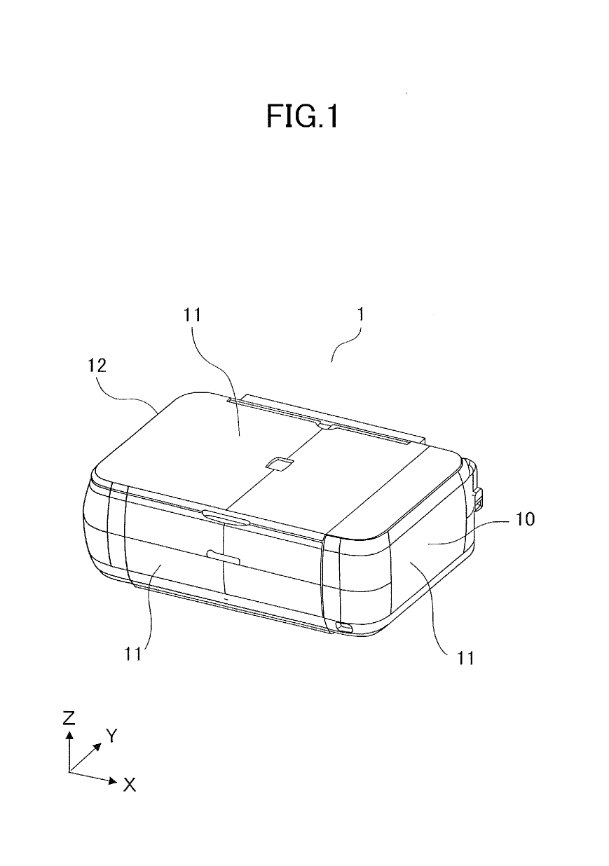

FIG. 1 is a perspective view of a printer in which a molded resin component of the present embodiment is used as an exterior component. FIG. 1 illustrates a multifunction printer 1. A document cover 12 and a housing 10 are made of white or black resin, for example. The top surface and side surfaces of the printer 1 constitute an exterior surface 11, which is seen by a user. Thus, since the exterior surface 11 is desired to have aesthetically excellent appearance, a molded resin component on which a decorative pattern is formed is used for a component such as the document cover 12.

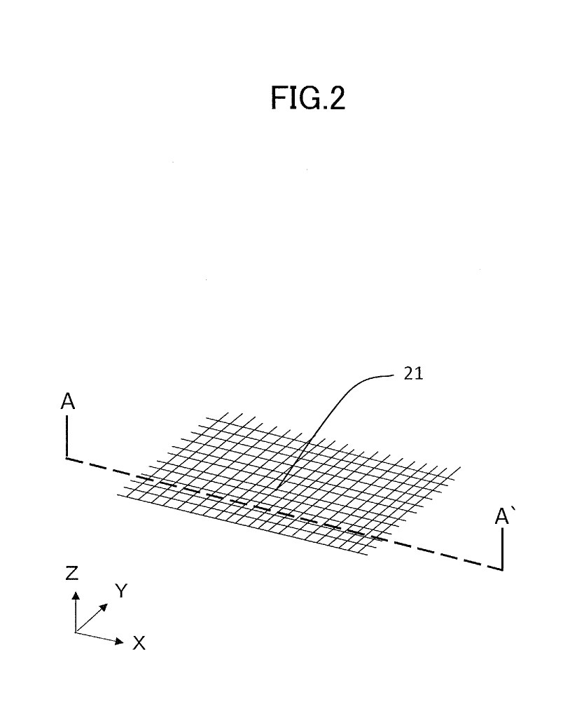

FIG. 2 schematically illustrates one example of the decorative pattern, which is formed on the top surface of the document cover 12 of the multifunction printer 1 of FIG. 1. FIG. 2 illustrates one portion 21 of the decorative pattern formed on the external surface of the molded resin component. The portion 21 has a convex portion formed like a lattice.

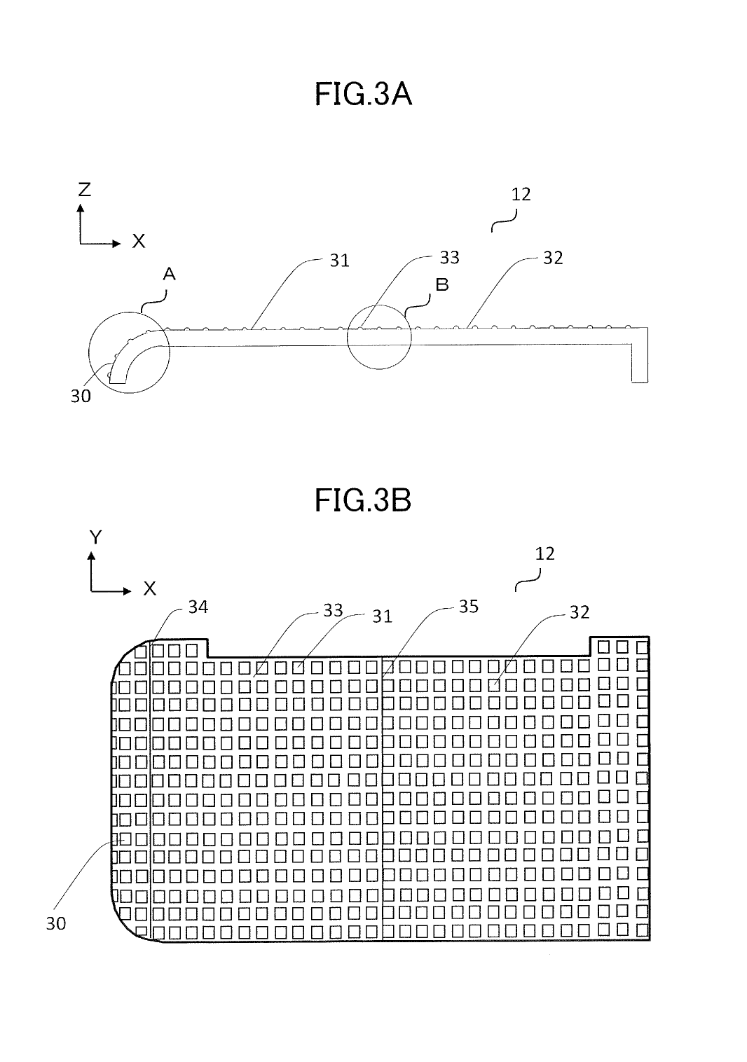

FIG. 3A is a schematic sectional view of the document cover 12, and FIG. 3B is a schematic top view of the document cover 12. FIG. 3A illustrates a cross section taken along a line A-A′ of FIG. 2.

The external surface of the document cover 12 is provided with the lattice-like pattern illustrated in FIG. 2. Specifically, the lattice-like convex portion is formed, as a decorative pattern, on a base surface of the document cover 12 which forms a basic shape of the external surface of the document cover 12. Thus, the convex portion protrudes from the base surface.

For aesthetic appearance, the base surface is a mirror surface, or has a high flatness which is almost the same as that of the mirror surface. Preferably, the base surface is a glossy surface. In the present embodiment, the base surface is a mirror surface.

A first base surface 30 forms a basic shape of a curved portion of the document cover 12. In FIG. 3A, the curved portion is located at the left edge of the document cover 12. A second base surface 31 forms a basic shape of an upper left surface of the document cover 12, and a third base surface 32 forms a basic shape of an upper right surface of the document cover 12.

The first to the third base surfaces 30 to 32 are provided with a convex portion 33, as a decorative pattern, such that the convex portion 33 is formed like a lattice when viewed from above.

A boundary line 34 indicates a parting step produced in the convex portion 33 having the decorative pattern. In addition, the second base surface 31 and the third base surface 32 are different in height in a Z direction. A boundary line 35 indicates a boundary between the second base surface 31 and the third base surface 32. Specific shapes of the vicinities of the boundary lines 34 and 35 will be described later.

Next, there will be described a method of manufacturing the document cover 12.

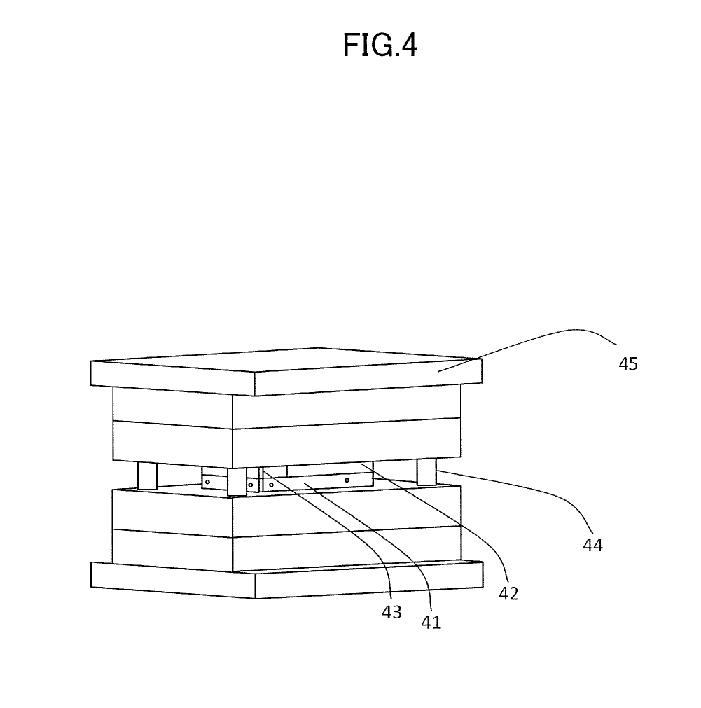

FIG. 4 illustrates an external view of a mold used for making the molded resin component. The mold includes a mold set having a plurality of pieces, which form a cavity space to be filled with resin.

In FIG. 4, a core piece 41 forms the back surface of the document cover 12, that is, a surface which is not the external surface of the document cover 12. A cavity piece 42 forms the front surface of the document cover 12, that is, an upper surface of the external surface including a decorative pattern. A slide piece 43 forms the front surface of the curved portion of the document cover 12, that is, the surface of a curved portion of the external surface including the decorative pattern. Die posts 44 guide the opening and closing of the mold, and a die set 45 receives pressure applied when the mold is closed.

Next, a configuration of the mold set having the pieces will be more specifically described.

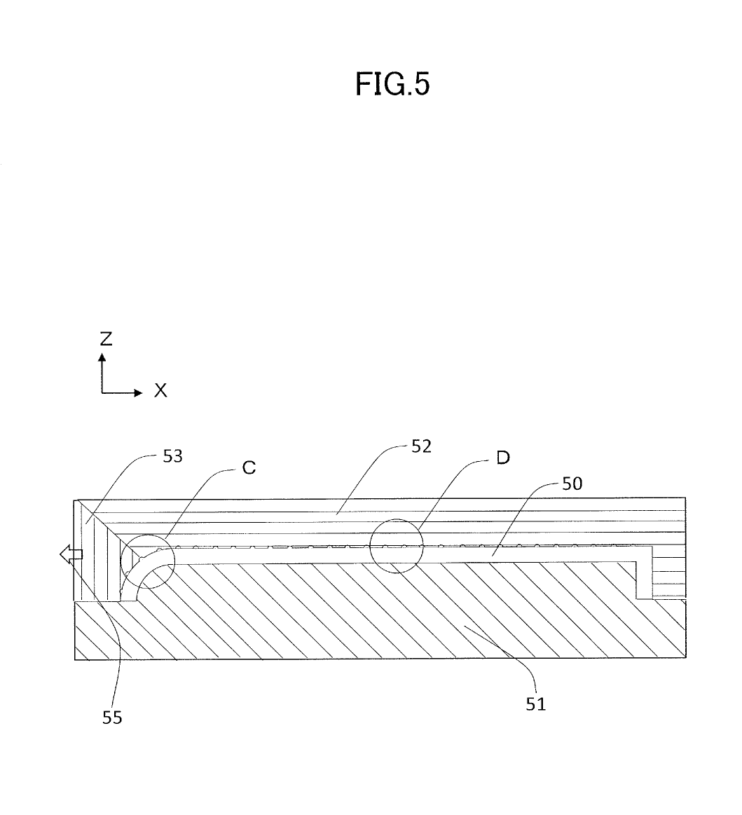

FIG. 5 is a sectional view illustrating the mold set used to manufacture the document cover 12, and illustrates a state where the resin is injected into a cavity formed by combining the pieces, and where the molded resin component is formed.

In FIG. 5, a core piece 51 forms the back surface of the document cover 12, that is, the surface which is not the external surface of the document cover 12. A cavity piece 52 forms the front surface of the document cover 12, that is, the upper surface of the external surface including a decorative pattern. A slide piece 53 forms the front surface of the curved portion of the document cover 12, that is, the surface of the curved portion of the external surface including the decorative pattern. An arrow 55 indicates a slide direction toward which the slide piece 53 is separated. In the cavity of the mold, a molded resin component 50 is formed for the document cover 12.

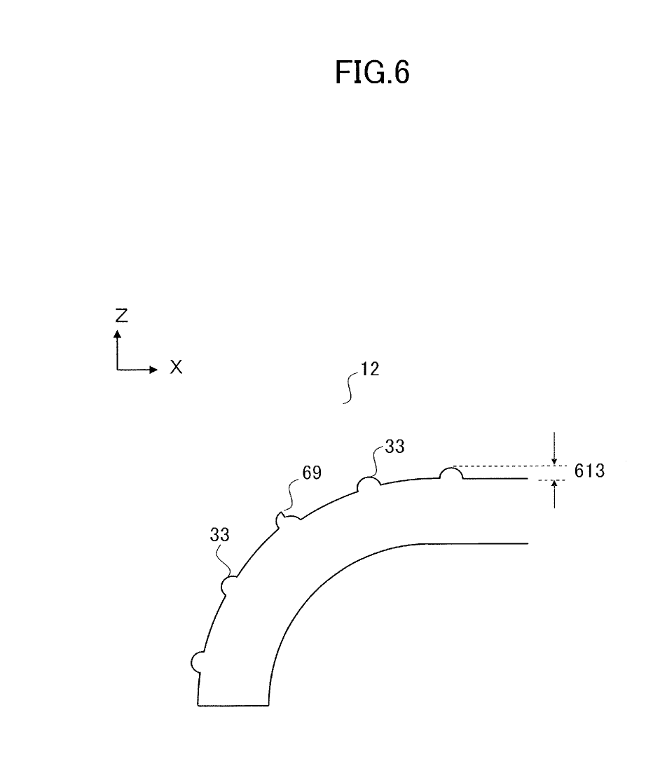

Next, the parting step of the present embodiment will be described in detail. The parting step is produced along the boundary line 34 illustrated in FIG. 3B, that is, produced in the convex portion 33 having the decorative pattern. FIG. 6 is a partial sectional view of the molded resin component in which a portion A illustrated in FIG. 3A is enlarged. As illustrated in FIG. 6, a parting step 69 is formed in the convex portion 33 having the decorative pattern. A height 613 of the convex portion 33 is measured from the base surface to the top of the convex portion 33. As described in later-described examples, for aesthetic appearance, the ratio of the height of the parting step 69 to the height 613 of the convex portion is preferably 60% or less, and more preferably, 50% or less. Here, the parting step 69 is the trace of a boundary between the pieces.

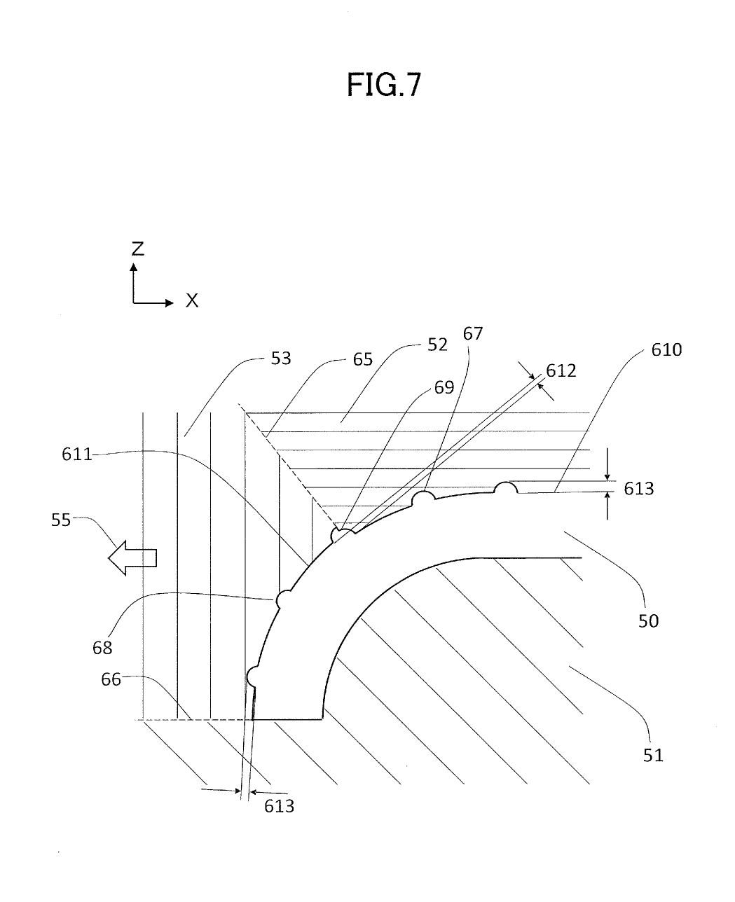

In the present embodiment, the parting step 69 is formed in the convex portion 33 having the decorative pattern. For describing this formation, FIG. 7 illustrates an enlarged view of a portion C illustrated in FIG. 5. In FIG. 7, the same portion as that of FIG. 5 is given the same reference numeral.

FIG. 7 illustrates a mating plane 65 between the cavity piece 52 and the slide piece 53, and a mating plane 66 between the core piece 51 and the slide piece 53.

The cavity piece 52 is provided with a concave portion 67, as a mold to form the decorative convex pattern on the top surface of the molded resin component 50. Here, the top surface is an external surface of the molded resin component 50. The depth of the concave portion 67 is equal to the height 613 of the convex pattern, measured from the base surface of the external surface of the molded resin component 50.

In addition, the slide piece 53 is provided with a concave portion 68, as a mold to form the decorative convex pattern on the external surface of the curved portion of the molded resin component 50. The depth of the concave portion 68 is equal to the height 613 of the convex pattern, measured from the base surface of the external surface of the molded resin component 50.

Thus, the cavity piece 52 and the slide piece 53 are provided with the concave portions arranged with regularity and corresponding to the decorative convex pattern. At the boundary between the cavity piece 52 and the slide piece 53, one portion of a concave portion is formed at an edge of the cavity piece 52, and the other portion of the concave portion is formed at an edge of the slide piece 53. Thus, when the cavity piece 52 and the slide piece 53 are joined with each other, the one portion and the other portion form a single convex pattern.

In the present embodiment, the parting step 69 as illustrated in FIG. 6, which is the trace of the boundary between the cavity piece 52 and the slide piece 53, is formed along the decorative convex pattern. Thus, the parting step 69 is visually less conspicuous. That is, since the parting step is arranged so as not to cross the decorative convex pattern, the design and the external appearance are less influenced, compared to a case where the parting step is formed in the base surface.

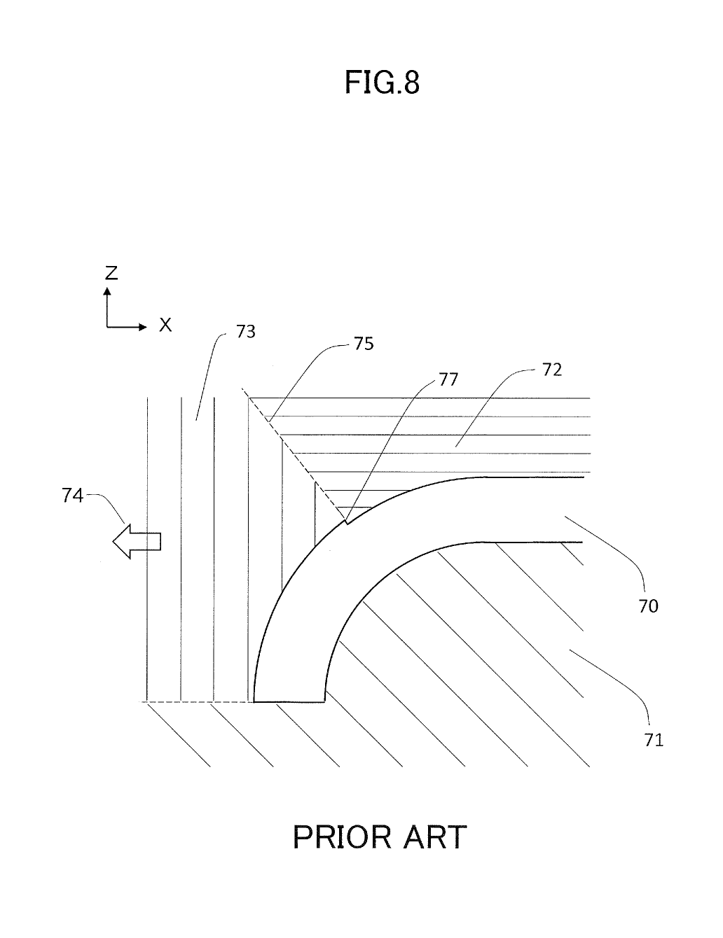

Here, the parting step produced between the cavity piece and the slide piece will be further described with reference to FIG. 8. FIG. 8 is a sectional view for illustrating the mechanism of occurrence of the parting step, and illustrates a case where the molded resin component 70 is manufactured by using a mold set including a core piece 71, a cavity piece 72, and a slide piece 73. An arrow 74 indicates a direction toward which the slide piece 73 is slid.

For allowing the slide piece 73 and the cavity piece 72 to slide, an allowance is provided in a boundary plane 75 between the slide piece 73 and the cavity piece 72. The allowance and the pressure applied by the resin in the mold will change a relative position of the slide piece 73 to the cavity piece 72, producing a step in the boundary between the slide piece 73 and the cavity piece 72. The step is transferred to the molded resin component, and a parting step 77 is produced. The height of the parting step 77 is not constant, and changes depending on many factors, such as molding conditions, precision of making the mold, and type of resin. Thus, it is actually difficult to eliminate the step by making the mold in consideration of the step. If the parting step 77 appears in the base surface, which is a reference surface of the external shape, the parting step 77 becomes highly visible, and significantly reduces quality of external appearance of the component.

In the present embodiment, as illustrated in FIG. 7, the decorative pattern is formed, in advance and with regularity, on the surface of the mold so that the parting step 69 is formed in the decorative pattern. As illustrated in FIG. 6, the parting step 69 is integrated with the convex portion 33 having the decorative pattern, by adjusting the position of the convex portion 33. This configuration can reduce visibility of the step, and prevent significant reduction in the external appearance for a user.

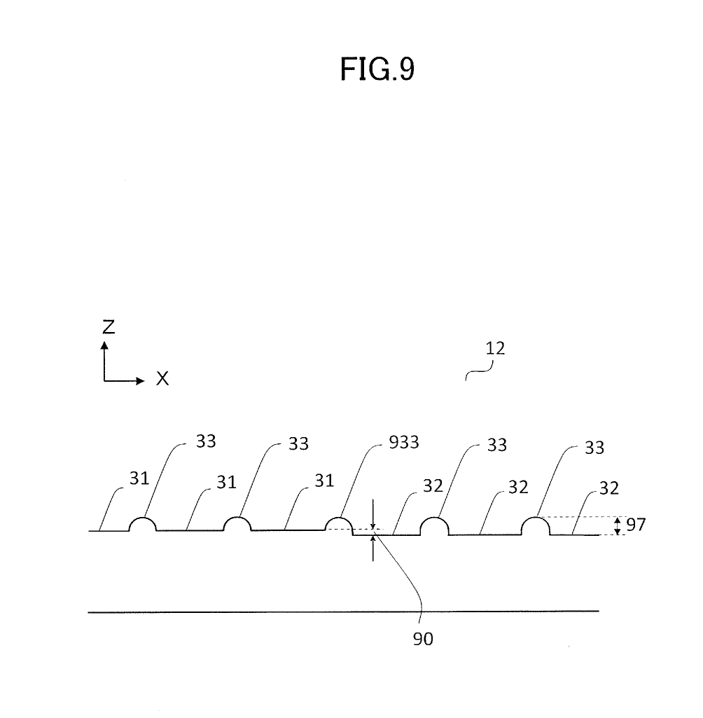

Next, a shape of the vicinity of the boundary line 35, as illustrated in FIG. 3B, between the second base surface 31 and the third base surface 32 will be described in detail. The second base surface 31 and the third base surface 32 are different in height in the Z direction. FIG. 9 is a sectional view in which a portion B illustrated in FIG. 3A is enlarged. As illustrated in FIG. 9, there is a difference 90 in height in the Z direction, between the second base surface 31 and the third base surface 32. Here, the second base surface 31 is formed on one side with respect to a convex portion 933 which is one portion of the decorative pattern, and the third base surface 32 is formed on the other side with respect to the convex portion 933.

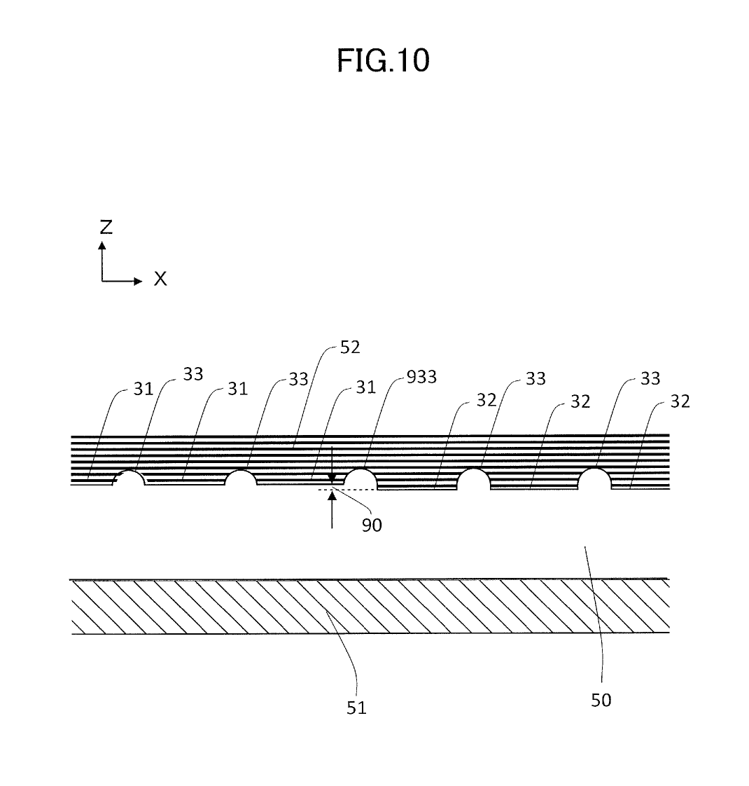

The mechanism of the occurrence of the step will be more specifically described. FIG. 10 is a sectional view in which a portion D illustrated in FIG. 5 is enlarged. In FIG. 10, the same portion as that of FIG. 5 is given the same reference numeral. FIG. 10 illustrates the molded resin component 50, the cavity piece 52, and the core piece 51. As illustrated in FIG. 10, the cavity piece 52 is formed such that the second base surface 31 and the third base surface 32 are different in height, with the convex portion 933 interposed between the second base surface 31 and the third base surface 32. The convex portion 933 is one portion of the decorative pattern of the molded resin component.

Next, the reason why the cavity piece is formed in this manner will be described.

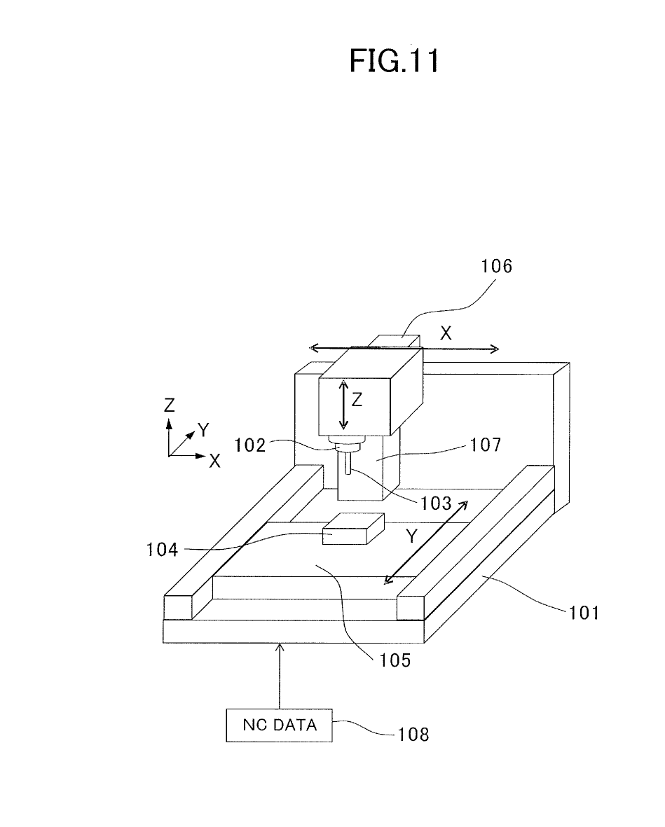

FIG. 11 is a perspective view illustrating a configuration of a machining center, which is a machine tool used to make the cavity piece 52. A machining center 101 has three linear axes of X, Y, and Z. A main spindle 102 cuts a workpiece 104, that is, a base material of the cavity piece, in a state where a cutting tool 103 is attached and rotated. A table 105 moves the workpiece 104 in a Y direction with respect to the cutting tool 103. A spindle saddle 106 moves the cutting tool 103 in an X direction with respect to the workpiece 104. A spindle guide 107 moves the cutting tool 103 in the Z direction with respect to the workpiece 104. A set of NC data 108 contains instruction data used for the cutting. For example, the instruction data contains amounts of movement in the X-, Y-, and Z-directions, the number of rotations of the main spindle, and speeds of movement in the X-, Y-, and Z-directions.

When the main spindle 102 moves and rotates at the number of rotations, feed speeds in those axes, and feeds per stroke in those axes, which are contained in the NC data 108, the cutting tool 103 can cut the workpiece 104. Thus, when the cutting tool 103 is attached to the main spindle 102 of the machining center 101, and the cutting tool 103 is moved relative to the workpiece 104 in a state where the main spindle 102 is rotating, the workpiece 104 can be machined into a predetermined three-dimensional shape.

When a molded resin component having a large external surface is molded with a mold, the number of parting steps increases as the number of pieces used to form the external surface increases. Thus, the less number of pieces is desirable, but causes each of the pieces to become larger. When a large cavity piece, enlarged due to the above-described reason, is made by using the above-described machining center, the cutting tool 103 wears during the cutting of the workpiece 104. Thus, the cutting tool 103 needs to be replaced with a new cutting tool in a sequential manner.

When the cutting tool 103 is replaced, the machining characteristic of the machine tool changes, causing difference in shape of the machined workpiece. Thus, the difference in shape becomes a step. In the following description, the difference in shape of the machined workpiece may be referred to as a tools-originated step.

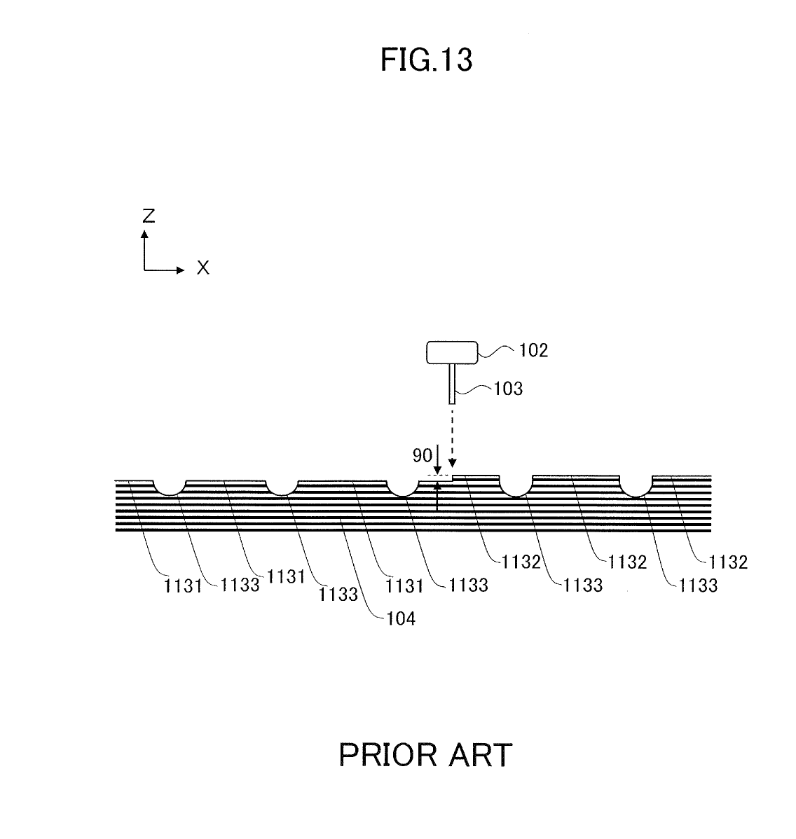

FIG. 13 is a schematic diagram for illustrating a conventional method of making a cavity piece having a decorative pattern. FIG. 13 illustrates a concave portion 1133, and flat surfaces 1131 and 1132. The concave portion 1133 is used to form the convex portion 33 of the molded resin component, having the decorative pattern; and the flat surfaces 1131 and 1132 form the base surface of the molded resin component.

For making a mold having such a shape, there are the following two methods, for example. A first method first forms a base surface by cutting a base material by using a tool suitable for the mirror-surface machining, and then forms the concave portion by using another tool having a different shape and suitable for the concave-portion machining. A second method forms the base surface and the concave portion together by cutting the base material by using a single tool, which is capable of forming the mirror surface and the concave portion. In the first method, since the tool for forming the base surface wears when used for a mold having a considerable size, the tool is required to be replaced with a new tool during the formation of the base surface. Also in the second method, since the tool wears when used for a mold having a considerable size, the tool is required to be replaced with a new tool during the machining.

Conventionally, when the machining center cuts the workpiece 104 to make the cavity piece, a position where a worn cutting tool is replaced with a new cutting tool is not controlled in the positional relationship between the position and the decorative pattern.

Thus, in both the first and the second methods, the cutting tool is often replaced with another during the formation of the base surface for a molded resin component. This replacement changes the machining characteristic; and causes a tools-originated step, having the height 90, to be formed in the base surface, as illustrated in FIG. 13.

When a molded resin component for the document cover 12 is made by using the cavity piece made in this manner, a step is formed in the base surface which serves as a reference of the outer shape. The step is visually conspicuous, and reduces quality of the external appearance.

Thus, it is desirable that the step is not formed in the production of the cavity piece. However, for a large molded resin component, it is actually difficult to make a corresponding cavity piece without replacing the cutting tool.

In the present embodiment, the step produced by the change in machining characteristic is prevented from being formed in the base surface, which serves as a reference of the outer shape, by adjusting a timing at which the cutting tool is replaced. That is, when a mold is made for molding a molded resin component having a decorative pattern, which is arranged on the base surface with predetermined regularity, the timing at which the cutting tool is replaced is adjusted so as not to replace the cutting tool when the cutting tool is cutting a surface of the mold corresponding to the base surface of the molded resin component. In other words, the cutting tool is replaced at a timing at which the cutting tool is cutting a portion of the mold corresponding to the decorative pattern, that is, a timing just before the cutting tool cuts the portion, a timing in a period of time in which the cutting tool cuts the portion, or a timing just after the cutting tool has cut the portion.

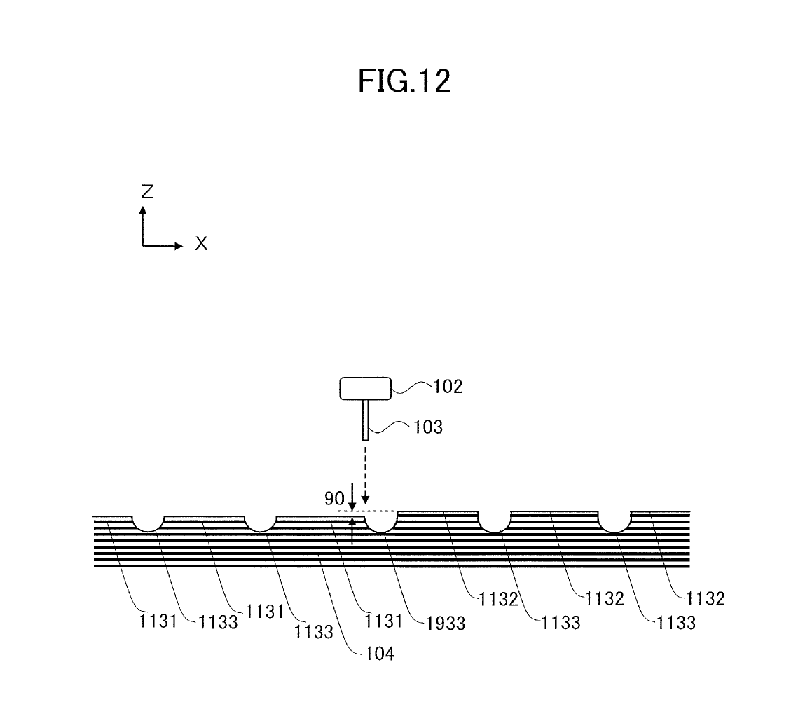

FIG. 12 is a schematic diagram for illustrating a method of making a cavity piece of the present embodiment. FIG. 12 illustrates a concave portion 1133, and flat surfaces 1131 and 1132. The concave portion 1133 is used to form the convex portion 33 of the molded resin component, having the decorative pattern; and the flat surfaces 1131 and 1132 form the base surface of the molded resin component.

In the present embodiment, the cutting tool 103 is replaced with another at a timing at which a surface of the mold, corresponding to the convex portion 33 having the decorative pattern, is cut. As illustrated in FIG. 12, in the present embodiment, the flat surfaces 1131 and 1132 are formed to form the base surface, with a concave portion 1933 serving as the boundary between the flat surfaces 1131 and 1132. The concave portion 1933 corresponds to a convex portion having the decorative pattern.

By using the cavity piece made in this manner, the molded resin component illustrated in FIG. 9 can be made for the document cover 12. Although the second base surface 31 and the third base surface 32 are different in height, the boundary between the second base surface 31 and the third base surface 32, or the tools-originated step is formed along the convex portion 933 having the decorative pattern. This formation allows the step to be visually less conspicuous, and prevents deterioration of quality of external appearance.

In other words, even though base surfaces on both sides of the convex portion 933 having the decorative pattern are different in height, the difference is visually less conspicuous.

Here, as described in later-described examples, for aesthetic appearance, the ratio of the difference 90 in height to the height 97 of the convex portion is preferably 60% or less, and more preferably, 50% or less.

### EXAMPLES

Hereinafter, specific examples of the molded resin component, used as a component of a printer and having a decorative pattern on its exterior surface, will be described.

### Configuration of Mold

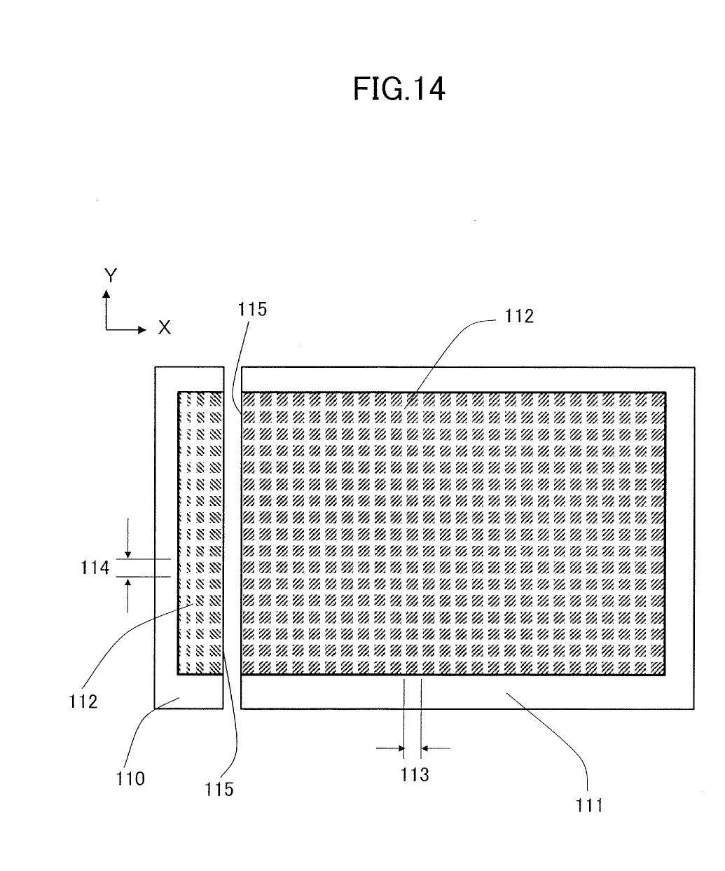

FIG. 14 illustrates a top view of a mold set used to make a molded resin component of Example 1, which has a decorative pattern. In FIG. 14, there are illustrated a cavity piece 111 and a slide piece 110. In addition, there are illustrated a concave portion 112 which makes a convex portion of resin component as a decorative pattern, a lateral-direction interval 113 of the bottom of the concave portion 112, and a longitudinal-direction interval 114 of the bottom of the concave portion 112. The lateral-direction interval 113 and the longitudinal-direction interval 114 correspond to a width and a height of one section of the base surface, respectively. Mating surfaces 115 of the cavity piece 111 and the slide piece 110 are surfaces on which the cavity piece 111 and the slide piece 110 join with each other. When a molded resin component is molded by using the cavity piece 111 and the slide piece 110, a parting step is produced in the mating surfaces 115.

### Making of Mold

Next, a method of forming a cavity surface and a slide surface of pieces of the mold will be described.

Pieces of mold sets of examples and pieces of later-described comparative examples were made by using a machine tool including the three-axis control machining center 101, the main spindle 102, and the cutting tool 103, which are illustrated in FIG. 11. The pieces were made by cutting the workpiece 104, depending on instructions contained in the NC data 108, such as amounts of movement in the X-, Y-, and Z-directions used in the cutting, the number of rotations of the main spindle, and speeds of movement in the X-, Y-, and Z-directions.

The cavity piece 111 and the slide piece 110 illustrated in FIG. 14 were made as examples. Specifically, the below-described thirteen examples were made. In the examples, the parting step was evaluated in Examples 1 to 4, and 10 to 11; and the tools-originated step was evaluated in Examples 5 to 9, and 12 to 13. In addition, Comparative Examples 1 and 2 were made as comparative examples to evaluate the parting step, and Comparative Examples 3 and 4 were made as comparative examples to evaluate the tools-originated step.

In the examples to evaluate the parting step, the size of the cavity piece 111 was 300 mm×200 mm, and the size of an area to which the decorative pattern was added was 250 mm×160 mm. The size of the slide piece 110 was 40 mm×200 mm, and the size of an area to which the decorative pattern was added was 20 mm×160 mm.

In these areas, the decorative pattern was formed by cutting the slide piece 110 and the cavity piece 111, by using an end mill. As illustrated in FIG. 14, the decorative pattern formed in this manner was a lattice-like pattern arranged with regularity. A lateral-direction line interval 113 of the lattice-like pattern was 5 mm, and a longitudinal-direction line interval 114 was 5 mm.

In the examples to evaluate the parting step, the lattice-like decorative pattern was adjusted in position so that the boundary between the mating surfaces 115 of the cavity piece 111 and the slide piece 110 is positioned in the lattice pattern. In addition, the height 613 of the decorative pattern illustrated in FIG. 7 was 0.05 mm in Examples 1, 2, and 10; and 0.1 mm in Examples 3, 4, and 11.

The tool used was a ball end mill having a ball-like tip, and the cutting was performed under a condition in which the shape of the tool is sufficiently transferred to the mold.

In the examples to evaluate the tools-originated step, the size of the cavity piece 111 to which the decorative pattern was added was 340 mm×200 mm, and the size of an area to which the decorative pattern was added was 250 mm×180 mm. In these areas, the decorative pattern was formed by cutting the cavity piece 111, by using an end mill.

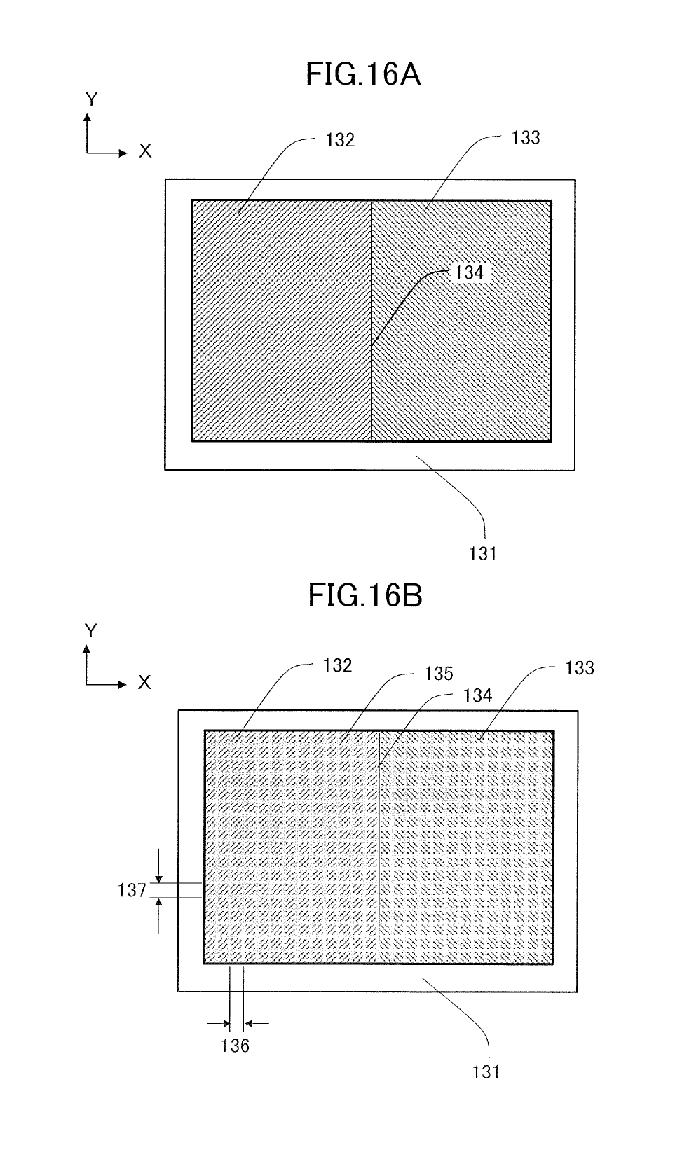

As illustrated in a plan view of FIG. 16B, the decorative pattern formed in this manner was a lattice-like pattern with regularity, and had a lateral-direction line interval 136 which was uniformly determined to be 5 mm, and a longitudinal-direction line interval 137 which was uniformly determined to be 5 mm. FIG. 16A is a plan view illustrating two areas 132 and 133. When the cavity piece was made, the area 132 was formed by using a first cutting tool, and the area 133 was formed by using a second cutting tool. In addition, the lattice-like pattern was adjusted in position so that the lattice-like pattern was arranged along a tools-originated step 134 produced on the boundary between the areas 132 and 133. The height of the tools-originated step 134 was 0.015 mm in Example 5, 0.025 mm in Example 6, 0.05 mm in Example 8, 0.03 mm in Example 12, and 0.06 mm in Example 13. The pattern height 97 of FIG. 9 was 0.05 mm in Examples 5 and 6, and 0.1 mm in Example 8. In FIG. 16B, the lateral-direction line interval 136 corresponds to a lateral interval of the top of the decorative lattice pattern, and the longitudinal-direction line interval 137 corresponds to a longitudinal interval of the top of the decorative lattice pattern.

Next, a method of making a mold which was used for Examples 7 and 9 will be described.

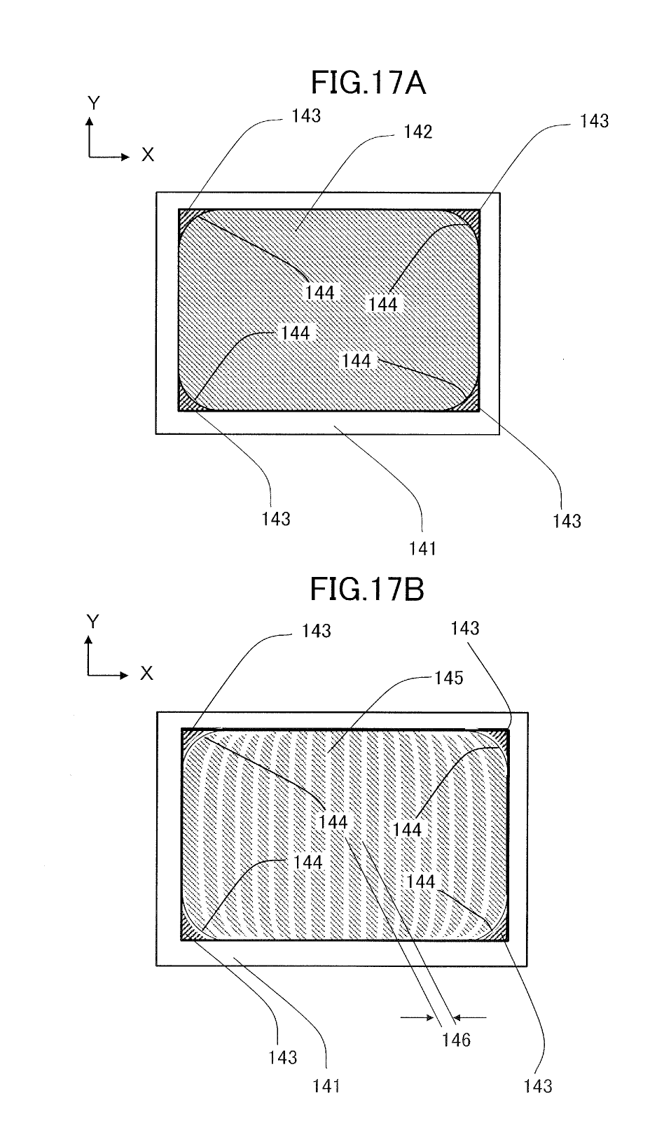

FIGS. 17A and 17B are top views of a cavity piece of the mold used for making molded resin components of Examples 7 and 9. In FIGS. 17A and 17B, a cavity piece 141 of the mold is formed such that the decorative pattern is gradually changed with regularity. In FIG. 17A, a machining area 142 is an area in which the cutting was performed by using a first tool to form a base surface of the cavity piece. The base surface is a surface of the cavity piece in which the decorative pattern is formed. A machining area 143 is an area in which the cutting was performed by using a second tool to form the base surface of the cavity piece. Here, there is illustrated a tools-originated step 144, which is a boundary line between the machining areas 142 and 143. In addition, there are illustrated concave portions 145 which make convex portions of resin components as the decorative pattern. The decorative pattern is formed so as to gradually change from a center portion toward a peripheral portion. The concave portions 145 are formed also in a position of the tools-originated step 144, which is the boundary between the machining area 142 formed by using the first tool and the machining area 143 formed by using the second tool. The concave portions 145 having the decorative pattern formed in the base surface have intervals 146 in a center portion.

As illustrated in FIG. 17B, the decorative pattern is formed like a line-and-space pattern, and the lateral-direction line intervals 146 are each uniformly determined to be 5 mm. The line-and-space pattern is gradually changed in position so that the line-and-space pattern is disposed on the tools-originated step 144, which is produced, as illustrated in FIG. 17A, between the machining area 142 formed by using the first tool and the machining area 143 formed by using the second tool.

The tools used were ball end mills having a ball-like tip. The cutting was performed under a condition in which the shapes of the tools are sufficiently transferred to the mold.

### Making of Molded Resin Components

The cavity piece and the slide piece, which had been made, were combined into a mold; and the molded resin components were obtained by performing the molding, by using the mold. In the molding, injection molding was performed by using white resin which was a PS material made by Toray Industries, Inc.; and the decorative lattice pattern formed in the cavity piece and the slide piece of the mold was transferred to the molded resin components. The molding machine used was an injection molding machine of J180EL3 (made by THE JAPAN STEEL WORKS, LTD.). The molding was performed under a molding condition which allows the decorative lattice pattern formed in the cavity piece surface and the slide piece surface of the mold to be sufficiently transferred.

In the examples to evaluate the parting step, a plurality of molded resin components were made. The molded resin components were made different in the parting step, that is, in the difference 612 in height between the base surface of the cavity piece 52 and the base surface of the slide piece 53, by adjusting positions of the cavity piece 52 and the slide piece 53 of FIG. 7. The parting step of the molded resin components was 0.015 mm in Example 1, 0.025 mm in Example 2, 0.025 mm in Example 3, 0.05 mm in Example 4, 0.03 mm in Example 10, and 0.06 mm in Example 11.

In the examples to evaluate the tools-originated step, the tools-originated step 144 of the examples was 0.025 mm in Example 7, and 0.05 mm in Example 9. The pattern height 97 of FIG. 9 was 0.05 mm in Example 7, and 0.1 mm in Example 9.

### COMPARATIVE EXAMPLES

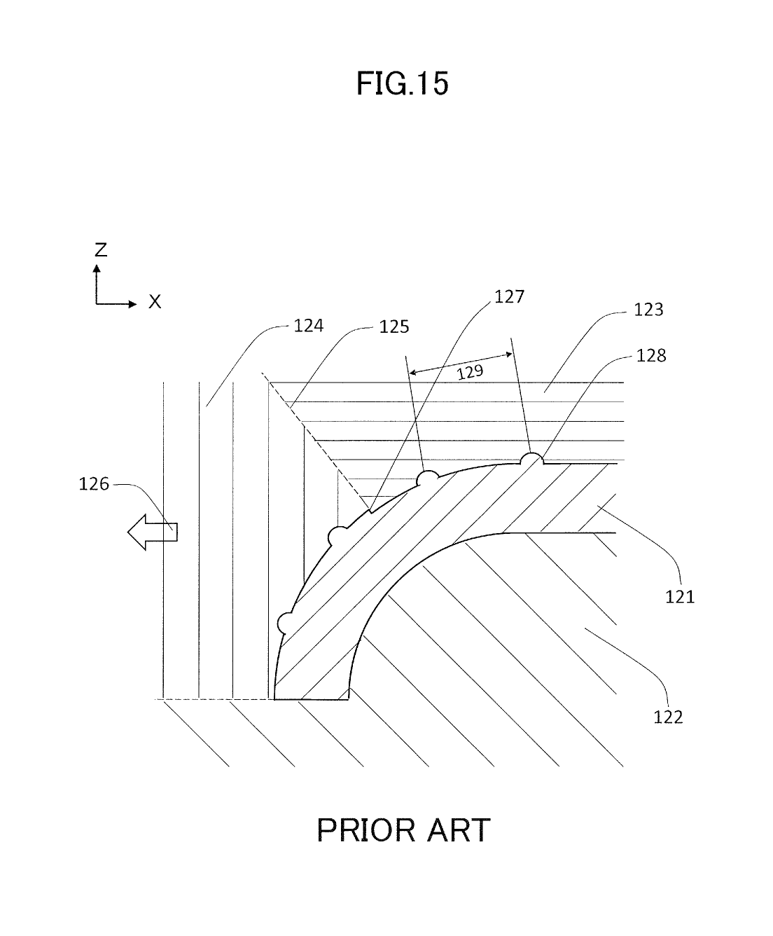

FIG. 15 illustrates a partial cross section of a mold set which was used to make molded resin components as comparative examples of the parting step. In Comparative Example 1, the parting step is formed not on the convex portion of the decorative pattern, but on the base surface. FIG. 15 illustrates a molded resin component 121 of Comparative Example 1, a core piece 122, a cavity piece 123, a slide piece 124, and mating surfaces 125 of the cavity piece 123 and the slide piece 124. FIG. 15 also illustrates a slide direction 126 of the slide piece 124, a parting step 127 produced between the cavity piece 123 and the slide piece 124, a convex portion 128 having the lattice-like pattern, and a line interval 129 of the lattice-like pattern.

In Comparative Example 1, the line interval 129 of the lattice-like pattern was 5 mm, as in the examples.

In Comparative Example 2, the molded resin component 70 was made by molding resin by using the mold of FIG. 8. Thus, the molded resin component 70 has no decorative pattern on its surface in the vicinity of the boundary between the slide piece and the cavity piece.

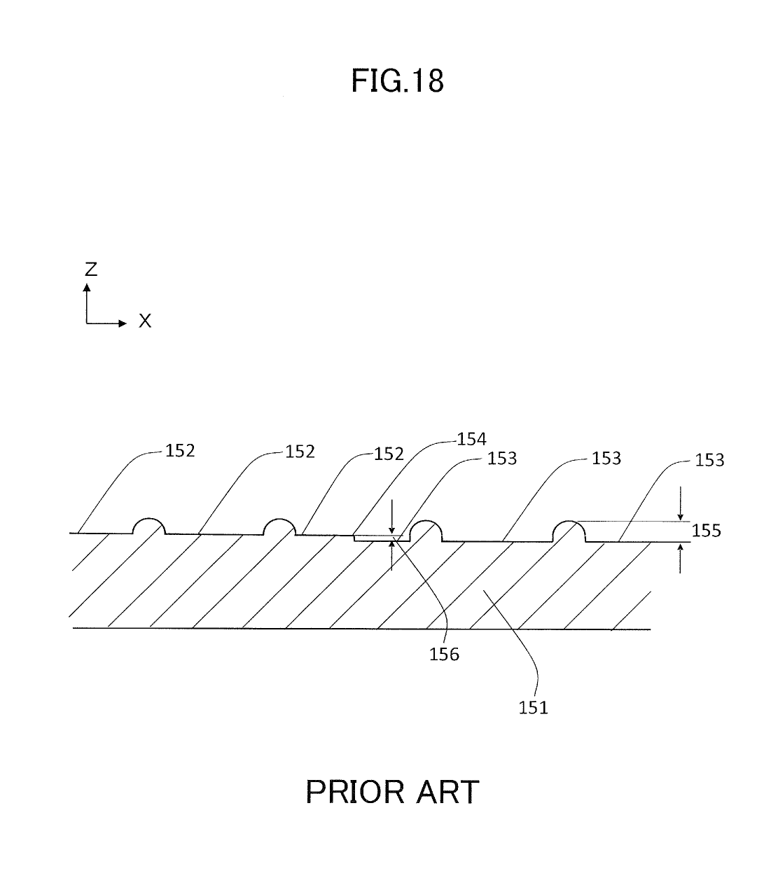

In Comparative Example 3 of the tools-originated step, there was made a molded resin component whose tools-originated step was formed outside the convex portion having the decorative pattern, that is, on the base surface. FIG. 18 illustrates an enlarged partial sectional view of the molded resin component. In FIG. 18, a molded resin component 151 is formed such that a tools-originated step on a surface of the molded resin component is formed outside the convex portion having the decorative pattern. A surface 152 is a surface into which a machining area formed by using a first tool was transferred to the molded resin component 151. The machining area is an area of a base surface of the cavity piece. A surface 153 is a surface into which a machining area formed by using a second tool was transferred to the molded resin component 151. The machining area is an area of the base surface of the cavity piece. A step 154 is a step into which a step produced between the machining area formed by using the first tool and the machining area formed by using the second tool was transferred to the molded resin component. The step between the machining areas is a step produced when the base surface of the cavity piece was formed to transfer the decorative pattern of the mold to the product. In addition, there are illustrated a height 155 of the pattern from the base surface to the top of the convex portion of the pattern, and a height 156 of the tools-originated step 154. In Comparative Example 3, the line interval of the lattice-like pattern was 5 mm, as in the examples.

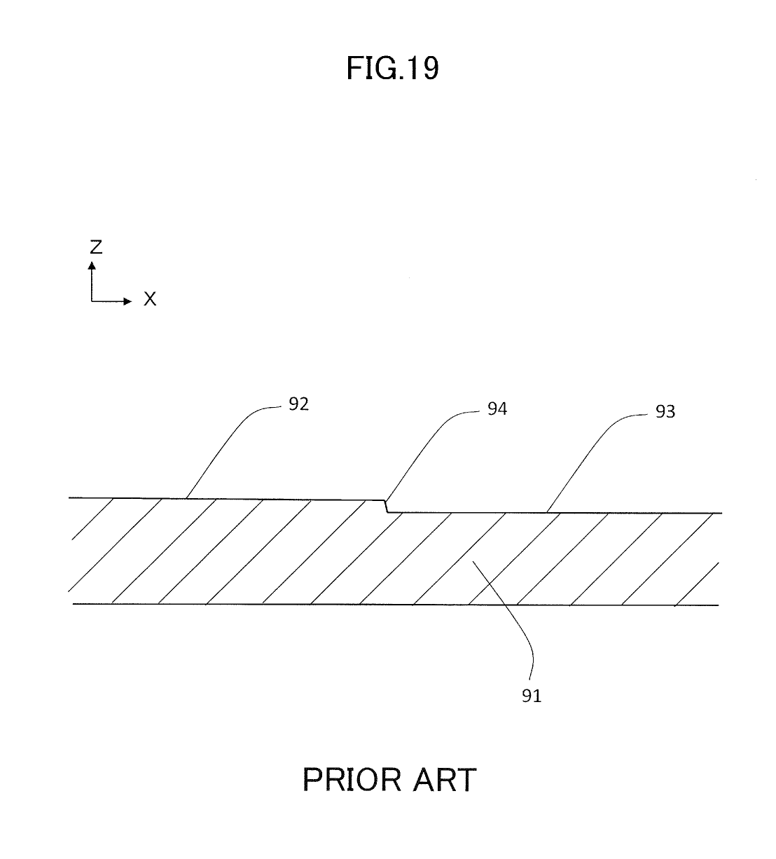

In Comparative Example 4, as illustrated in an enlarged sectional view of FIG. 19, a molded resin component 91 was made by using a cavity piece having no decorative pattern on its surface. FIG. 19 illustrates the molded resin component 91 having no decorative pattern. A first base surface 92 is a surface into which a base surface formed by using a first tool, used when a cavity piece surface was machined, was transferred to the molded resin component 91. A second base surface 93 is a surface into which a base surface formed by using a second tool, used when the cavity piece surface was machined, was transferred to the molded resin component 91. A portion 94 is a portion into which a step produced between the first base surface formed by using the first tool and the second base surface formed by using the second tool was transferred to the molded resin component. Evaluation

The molded resin components of Examples 1 to 13 and Comparative Examples 1 to 4, obtained by using injection molding, were evaluated by five skilled workers who routinely check the external appearance. In the evaluation, whether the parting step, which is produced between the cavity piece and the slide piece, and the tools-originated step can be visually recognized was evaluated in five grades. When a step was more difficult to recognize, a higher grade was given. The evaluation criterion was as follows: grade C was given when the average of five evaluation results was 2 or less, grade B was given when the average of the five evaluation results was 3 to 4, and grade A was given when the average of the five evaluation results was 5. Table 1 indicates the evaluation results.

TABLE 1

| | | pattern | difference | step height/ | | | |
|---|---|---|---|---|---|---|---|
| | | height | in height | pattern height | line | step | |
| | step type | [mm] | [mm] | [%] | interval | position | evaluation |
| Example 1 | parting | 0.05 | 0.015 | 30% | fixed | inside pattern | A |
| Example 2 | | 0.05 | 0.025 | 50% | fixed | inside pattern | A |
| Example 3 | | 0.1 | 0.025 | 25% | fixed | inside pattern | A |
| Example 4 | | 0.1 | 0.05 | 50% | fixed | inside pattern | A |
| Example 5 | tools- | 0.05 | 0.015 | 30% | fixed | inside pattern | A |
| Example 6 | originated | 0.05 | 0.025 | 50% | fixed | inside pattern | A |
| Example 7 | | 0.05 | 0.025 | 50% | gradually | inside pattern | A |
| | | | | | changed | | |
| Example 8 | | 0.1 | 0.05 | 50% | fixed | inside pattern | A |
| Example 9 | | 0.1 | 0.05 | 50% | gradually | inside pattern | A |
| | | | | | changed | | |
| Example 10 | parting | 0.05 | 0.03 | 60% | fixed | inside pattern | B |
| Example 11 | | 0.1 | 0.06 | 60% | fixed | inside pattern | B |
| Example 12 | tools- | 0.05 | 0.03 | 60% | fixed | inside pattern | B |
| Example 13 | originated | 0.1 | 0.06 | 60% | fixed | inside pattern | B |
| Comparative | parting | 0.05 | 0.005 | 10% | fixed | outside pattern | C |
| Example 1 | | | | | | | |
| Comparative | | 0 | 0.005 | — | — | — | C |
| Example 2 | | | | | | | |
| Comparative | tools- | 0.05 | 0.005 | 10% | fixed | outside pattern | C |
| Example 3 | originated | | | | | | |
| Comparative | | 0 | 0.005 | — | — | — | C |
| Example 4 | | | | | | | |

As can be seen, since the parting steps of Examples 1 to 4 and 10 to 11 were each integrally formed with the convex portion having the decorative pattern, they were more difficult to recognize than Comparative Examples 1 to 2, even though the height of the steps is large.

In addition, since the tools-originated steps of Examples 5 to 9 and 12 to 13 were each integrally formed with the convex portion having the decorative pattern, they were more difficult to recognize than Comparative Examples 3 to 4, even though the height of the tools-originated steps is large.

In the examples, the evaluation was excellent when the ratio of the height of the step to the height of the convex portion having the decorative pattern was 60% or less, and more excellent when the ratio was 50% or less.

As described above, the present invention produces the effect in which the aesthetic appearance in design is prevented from deteriorating, by adjusting the arrangement of the decorative pattern so that the step, produced in a molded resin component having a decorative pattern, is formed in a visually less conspicuous position.

The present invention, however, is not limited to the above-described embodiments and examples. Thus, embodiments of the present disclosure may be appropriately modified or combined.

For example, the decorative pattern is not limited to the lattice pattern illustrated in FIGS. 2, 3A, and 3B, and to the line-and-space pattern, which is illustrated in FIGS. 17A and 17B, and in which the linear convex portions are arranged at predetermined intervals; and may be any pattern as long as the pattern has an aesthetic appearance. However, since the visibility of the step is reduced by integrally forming the step with the pattern, the pattern has only to have regularity which viewers feel natural.

Here, the regularity typically means repetition of the same shape and the same interval, but is not limited to this. For example, in the regularity, the area, the shape, or the interval of a pattern may be gradually changed at a predetermined rate of change.

In the above-described embodiments, in order to form the parting step in the convex pattern, both pieces are each provided with one portion of a single concave portion, used to form a corresponding convex pattern, at an edge of each piece so that the single convex portion is formed when both pieces are joined with each other. However, for reducing the visibility of the parting step, the parting step may be formed not at a center of the convex pattern, but at an edge of the convex pattern. Thus, the concave portion used to form the convex pattern may be formed at an edge of one of two pieces, which contact with each other via the boundary between the two pieces.

In addition, the parting step to which the present invention is applied is not limited to the step between the cavity piece and the slide piece. For example, even for a step in a boundary portion of another piece, such as a step produced when an insert piece is set to the cavity piece, the visibility of the step can be reduced by forming a mold such that a corresponding decorative pattern is formed along the boundary portion.

In addition, the molded resin component of the present invention is not limited to exterior components of printers, and may be any of exterior components of other home electrical products and electronic products, or exterior or interior components of vehicles such as automobiles.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-180811, filed Sep. 21, 2017, which is hereby incorporated by reference herein in its entirety.

What is claimed is:

1. A method of manufacturing a molded resin component having a regular decorative pattern by filling a cavity with resin, the cavity being formed by a mold set including a first piece and a second piece, the regular decorative pattern having a convex portion, the method comprising:
using a mold set in which a concave part is formed along a boundary portion between the first piece and the second piece, the concave part being used to form one portion of the convex portion of the regular decorative pattern; or
using a mold set including a first base surface, a second base surface which positioned higher than the first base surface, a concave part between the first base surface and the second base surface, and a step formed by a cutting tool being replaced at a position where the concave part is to be formed, the concave part being used to form one portion of the convex portion of the regular decorative pattern.

2. The method according to claim 1, wherein the regular decorative pattern comprises a plurality of convex parts, having an identical shape, repeatedly arranged at regular intervals.

3. The method according to claim 1, wherein the regular decorative pattern comprises a plurality of convex parts, being arranged such that an area and/or a shape and/or an interval of convex part is gradually changed at a predetermined rate of change.

4. The method according to claim 1, wherein the convex portion comprises a plurality of linear convex parts arranged at predetermined intervals.

5. The method according to claim 1, wherein the convex portion is formed like a lattice.

6. A molded resin component having a regular decorative pattern, the regular decorative pattern including a convex portion, the molded resin component comprising a step in one portion of the convex portion of the regular decorative pattern.

7. The molded resin component according to claim 6, wherein the step is a trace of a boundary between pieces of a mold set used to mold the molded resin component.

8. The molded resin component according to claim 6, wherein the one portion of the convex portion is arranged between a first base surface and a second base surface which positioned higher than the first base surface, the one portion of the convex portion comprising a first edge connected to the first base surface and a second edge connected to the second base surface,
wherein a height of the step correspond to a height difference between the first edge and the second edge,
wherein the step has a shape into which a shape of a mold has been transferred to the molded resin component,
wherein the shape of the mold is formed by a cutting tool being replaced at a position where a concave part is to be formed, the concave part being used to form the one portion of the convex portion.

9. The molded resin component according to claim 6, wherein a ratio of a height of the step to a height of the convex portion is 60% or less.

10. The molded resin component according to claim 6, wherein the regular decorative pattern comprises a plurality of convex parts, having an identical shape, repeatedly arranged at regular intervals.

11. The molded resin component according to claim 6, wherein the regular decorative pattern comprises a plurality of convex parts, being arranged such that an area and/or a shape and/or an interval of convex part is gradually changed at a predetermined rate of change.

12. The molded resin component according to claim 6, wherein the convex portion is constituted by a plurality of linear convex parts arranged at predetermined intervals.

13. The molded resin component according to claim 6, wherein the convex portion has a shape like a lattice.

14. A printer having a molded resin component on an exterior surface thereof, the molded resin component including a regular decorative pattern, the regular decorative pattern including a convex portion, the printer comprising a step in one portion of the convex portion of the regular decorative pattern.

15. The printer according to claim 14, wherein a ratio of a height of the step to a height of the convex portion is 60% or less.

16. The printer according to claim 14, wherein the regular decorative pattern comprises a plurality of convex parts, having an identical shape, repeatedly arranged at regular intervals.

17. The printer according to claim 14, wherein the regular decorative pattern comprises a plurality of convex parts, being arranged such that an area and/or a shape and/or an interval of convex part is gradually changed at a predetermined rate of change.

18. The printer according to claim 14, wherein the convex portion is constituted by a plurality of linear convex parts arranged at predetermined intervals.

19. The printer according to claim 14, wherein the convex portion has a shape like a lattice.
